(19) United States
(12) Patent Application Publication
(10) Pub. No.: US 2026/0111373 A1
(43) Pub. Date: Apr. 23, 2026

(54) PROCESSING INPUT/OUTPUT REQUESTS

(71) Applicant: Dell Products L.P., Round Rock, TX (US)

(72) Inventors: Vitaly Zharkov, Modiin (IL); Eldad Zinger, Raanana (IL); Elad Grupi, Pardes Hana (IL)

(21) Appl. No.: 18/924,232

(22) Filed: Oct. 23, 2024

(51) Int. Cl. G06F 13/20

(52) U.S. Cl. CPC G06F 13/20; G06F 2213/40

(57) ABSTRACT

A technique for processing IO requests includes applying release timestamps to respective IO requests received from a set of hosts, the IO requests directed to multiple data objects, the release timestamps indicating when to release the respective IO requests for processing. The technique further includes, based on the release timestamps, assigning the IO requests to N bins provided for N respective ranges of release times, said assigning producing N groups of IO requests in the N bins. The technique still further includes releasing the N groups of IO requests in sequence based on a current time sequentially aligning with each of the N respective ranges of release times.

### BACKGROUND

Data storage systems are arrangements of hardware and software in which storage processors are coupled to arrays of non-volatile storage devices, such as magnetic disk drives, electronic flash drives, and/or optical drives. The storage processors, also referred to herein as “nodes,” service storage requests arriving from host machines (“hosts”), which specify blocks, files, and/or other data elements to be written, read, created, deleted, and so forth. Software running on the nodes manages incoming storage requests and performs various data processing tasks to organize and secure the data elements on the non-volatile storage devices.

A storage system may store its data in data objects, such as volumes or volume groups, and may balance workloads for different applications and/or users. In one scheme, separate waiting queues are provided for respective data objects. When the system receives an IO request directed to a particular data object, the system calculates a timestamp for the IO request and places the IO request along with the associated timestamp in the queue provided for that data object. The timestamp indicates when to release the IO request and may be based on quality-of-service (QoS) requirements set by a service-level agreement (SLA), for example. To “release” the IO request means to stop holding back the IO request and to allow it to be processed by the system.

### SUMMARY

Unfortunately, providing separate waiting queues for respective data objects has deficiencies. Along these lines, the storage system may individually check each of the queues to determine whether the queues contain any IO requests having timestamps at or before the current time, indicating IO requests that are ready for processing. As the queues are provided for respective data objects, adding more data objects to the system increases the number of queues that the storage system must check. As a result, the system spends additional time and computing resources checking the queues, regardless of whether the queues actually contain any IO requests that are ready for processing.

Further, adding more queues decreases how quickly the system can check the queues. The system may check the queues in continuous cycles, such that when the system finishes checking all of the queues, the system immediately begins checking the queues again. Adding more queues can increase the time that the system spends checking the queues in a given cycle, which can delay the start of the next cycle. As a result, the system is slower to determine whether IO requests are ready for processing, causing the IO requests to remain in the queues for longer and potentially resulting in a failure to meet QoS requirements. What is needed, therefore, is a more scalable way of selecting IO requests for processing.

The above need is addressed at least in part by an improved technique that sorts IO requests into bins covering consecutive time slices. When a system receives IO requests directed to various data objects, the system assigns the IO requests to bins based on release timestamps calculated for those IO requests. According to this arrangement, the system releases IO requests for processing by selecting a bin based on a current time and releasing the IO requests from the selected bin. The IO requests released from the selected bin may be directed to any number of data objects.

Advantageously, providing bins based on time slices avoids the need to check separate waiting queues on a per-data-object basis when releasing IO requests for processing. Instead, the system need only check a single bin based on the current time for any number of data objects. As a result, the system may increase the number of data objects without increasing the number of bins, improving the scalability of the system.

Certain embodiments are directed to a method of processing IO requests. The method includes applying release timestamps to respective IO requests received from a set of hosts, the IO requests directed to multiple data objects. The release times indicate when to release the respective IO requests for processing. The method further includes, based on the release timestamps, assigning the IO requests to N bins provided for N respective ranges of release times. Said assigning produces N groups of IO requests in the N bins. The method still further includes releasing the N groups of IO requests in sequence based on a current time sequentially aligning with each of the N respective ranges of release times.

Other embodiments are directed to a computerized apparatus constructed and arranged to perform a method of processing IO requests, such as the method described above. Still other embodiments are directed to a computer program product. The computer program product stores instructions which, when executed on control circuitry of a computerized apparatus, cause the computerized apparatus to perform a method of processing IO requests, such as the method described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a block diagram of an example environment in which embodiments of the improved technique can be practiced.

FIG. 2 is a block diagram showing IO requests being assigned to a bin of the example environment of FIG. 1.

FIG. 3 is a block diagram showing additional features of a bin of the example environment of FIG. 1.

FIG. 4 is a block diagram showing IO requests being removed from a bin of the example environment of FIG. 1.

FIG. 5 is a block diagram showing IO requests being assigned and removed from a bin of the example environment of FIG. 1.

FIG. 6 is a flowchart showing an example method of assigning IO requests to a bin.

FIG. 7 is a flowchart showing an example method of removing IO requests from a bin.

FIG. 8 is a flowchart showing an example method of processing IO requests.

### DETAILED DESCRIPTION

Embodiments of the improved technique will now be described. One should appreciate that such embodiments are provided by way of example to illustrate certain features and principles but are not intended to be limiting.

An improved technique is directed to sorting IO requests into bins covering consecutive time slices. When a system receives IO requests directed to various data objects, the system assigns the IO requests to bins based on a release timestamp calculated for the IO requests. According to this arrangement, the system releases the IO requests for processing by selecting a bin based on the current time and releasing the IO requests from that bin. The IO requests released from the selected bin may be directed to any number of data objects.

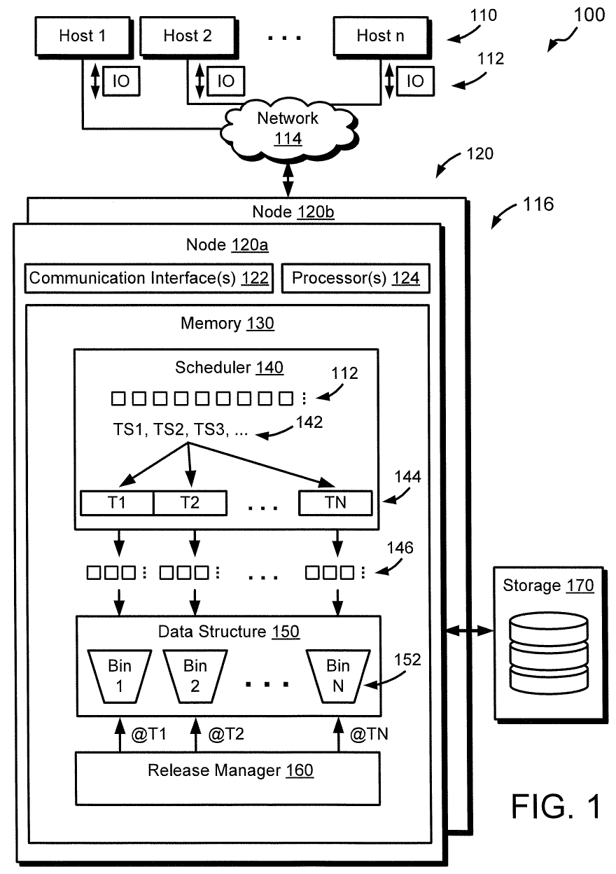

FIG. 1 shows an example environment 100 in which embodiments of the improved technique can be practiced. Here, multiple hosts 110 are configured to access a data storage system 116 over a network 114. The data storage system 116 includes one or more nodes 120 (e.g., node 120a and node 120b), and storage 170, such as magnetic disk drives, electronic flash drives, and/or the like. Nodes 120 may be provided as circuit board assemblies or blades, which plug into a chassis (not shown) that encloses and cools the nodes. The chassis has a backplane or midplane for interconnecting the nodes 120, and additional connections may be made among nodes 120 using cables. In some examples, the nodes 120 are part of a storage cluster, such as one which contains any number of storage appliances, where each appliance includes a pair of nodes 120 connected to shared storage. In some arrangements, a host application runs directly on the nodes 120, such that separate host machines 110 need not be present. No particular hardware configuration is required, however, as any number of nodes 120 may be provided, including a single node, in any arrangement, and the node or nodes 120 can be any type or types of computing device capable of running software and processing host IO's.

The network 114 may be any type of network or combination of networks, such as a storage area network (SAN), a local area network (LAN), a wide area network (WAN), the Internet, and/or some other type of network or combination of networks, for example. In cases where hosts 110 are provided, such hosts 110 may connect to the node 120 using various technologies, such as Fibre Channel, iSCSI (Internet small computer system interface), NVMeOF (Nonvolatile Memory Express (NVMe) over Fabrics), NFS (network file system), and CIFS (common Internet file system), for example. As is known, Fibre Channel, iSCSI, and NVMeOF are block-based protocols, whereas NFS and CIFS are file-based protocols. The node 120 is configured to receive IO requests 112 according to block-based and/or file-based protocols and to respond to such IO requests 112 by reading or writing the storage 170.

The depiction of node 120a is intended to be representative of all nodes 120. As shown, node 120a includes one or more communication interfaces 122, a set of processors 124, and memory 130. The communication interfaces 122 include, for example, SCSI target adapters and/or network interface adapters for converting electronic and/or optical signals received over the network 114 to electronic form for use by the node 120a. The set of processors 124 includes one or more processing chips and/or assemblies, such as numerous multi-core CPUs (central processing units). The memory 130 includes both volatile memory, e.g., RAM (Random Access Memory), and non-volatile memory, such as one or more ROMs (Read-Only Memories), disk drives, solid state drives, and the like. The set of processors 124 and the memory 130 together form control circuitry, which is constructed and arranged to carry out various methods and functions as described herein. Also, the memory 130 includes a variety of software constructs realized in the form of executable instructions.

When the executable instructions are run by the set of processors 124, the set of processors 124 is made to carry out the operations of the software constructs. Although certain software constructs are specifically shown and described, it is understood that the memory 130 typically includes many other software components, which are not shown, such as an operating system, various applications, processes, and daemons.

As further shown in FIG. 1, the memory 130 “includes,” i.e., realizes by execution of software instructions, a scheduler 140, a data structure 150, and a release manager 160.

The scheduler 140 is configured to apply respective release timestamps 142 to the IO requests 112 received from the hosts 110. The release timestamps 142 indicate when to release the IO requests 112 for processing and may be based on quality-of-service (QoS) requirements from service-level agreements (SLAs), for example. The scheduler 140 is further configured to sort the release timestamps 142 into N contiguous time ranges 144 (e.g., T1, T2, . . . , TN) of release times. Preferably, each of the N time ranges 144 span a common length of time. In some embodiments, N is an integer greater than one.

The data structure 150 provides N respective bins 152 (e.g., bins 1, 2, . . . , N) for the N time ranges 144. As shown, bin 1 is provided for time range T1, bin 2 is provided time range T2, and so forth. Based on the release timestamps 142 in each of the N time ranges 144, the scheduler 140 is configured to assign the IO requests 112 to the N bins 152 to produce N groups 146 of IO requests in the N bins 152. The IO requests 112 in each of the N groups 146 of IO requests may be directed to multiple data objects in the storage 170. Preferably, the data structure 150 is a one-dimensional structure, with each element in the structure providing one of the N bins 152.

The release manager 160 is configured to selectively release the IO requests 112 from the N bins 152. Along these lines, the release manager 160 may release the N groups 146 of IO requests from the N bins 152 in sequence based on the current time sequentially aligning with each of the N time ranges 144. For example, the release manager 160 may release the group 146 of IO requests from bin 1 when the current time aligns with time range T1, the release manager 160 may release the group 146 of IO requests from bin 2 when the current time aligns with time range T2, and so forth.

In example operation, the hosts 110 issue the IO requests 112 to the data storage system 116. The node 120 receives the IO requests 112 at the communication interfaces 122 and provides the IO requests 112 to the scheduler 140. The scheduler 140 applies release timestamps 142 and sorts the release timestamps 142 into the N time ranges 144 of release times. Based on the release timestamps 142 in the N time ranges 144, the scheduler 140 assigns the respective IO requests 112 to the N bins 152 provided for the N time ranges 144. Assigning the IO requests 112 in this manner produces the N groups 146 of IO requests in the N bins 152.

Further during example operation, the release manager 160 releases the N groups 146 of IO requests from the N bins 152 in sequence based on the current time advancing to sequentially align with each of the N time ranges 144. That is, while the current time aligns with a particular time range, the release manager 160 releases a respective group of IO requests from a bin provided for the particular time range. In this manner, IO requests in the same bin with release timestamps that are close in time may be released together for processing.

Advantageously, grouping IO requests by release time rather than by data object avoids the need to check separate waiting queues for respective data objects when releasing IO requests for processing. Instead, the IO requests 112 in a bin may be directed to multiple data objects, and the release manager 160 may release all of the IO requests 112 from a bin together, regardless of the data objects to which the IO requests 112 are directed. Thus, the number of data objects in the storage 170 may be increased without negatively affecting how quickly the release manager 160 identifies IO requests to release, thereby improving the scalability of the system.

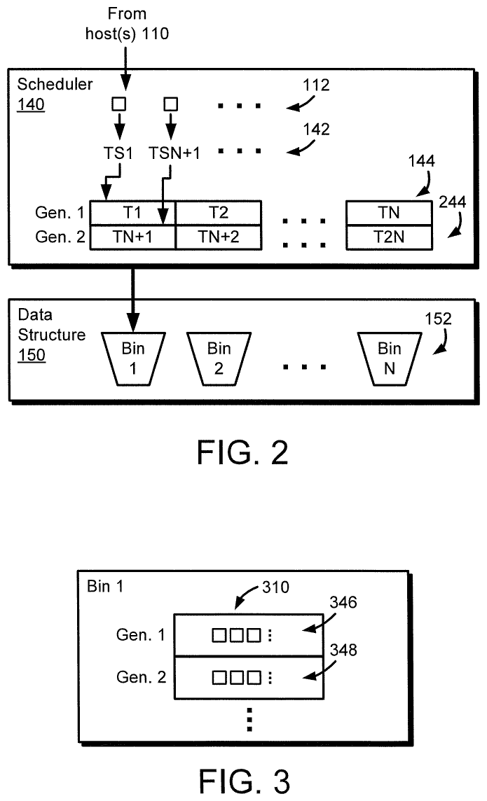

FIG. 2 shows additional features of the example environment 100 in which the IO requests 112 are assigned to the N bins 152 in multiple generations. These generations accommodate release timestamps farther into the future than the N time slices directly allow. As shown, the N time ranges 144 (time ranges T1 through TN) form a first generation (Gen. 1) of contiguous time ranges. Further, an additional N time ranges 244 (times ranges TN+1 through T2N) form a second generation (Gen. 2) of contiguous time ranges immediately following the last time range of the previous generation, i.e., TN of the N time ranges 144. In this manner, the first time range T1 of the first generation and the first time range TN+1 of the second generation are separated by a total of N−1 time ranges. The scheduler 140 is configured to assign the IO requests 112 having timestamps within multiple generations to a single bin of the N bins 152.

Preferably, the generations span a common length of time (referred to herein as a “generation interval”), e.g., 100 milliseconds, which is the sum of time intervals represented by the N time slices 144. In some embodiments, the generation interval is established as an interval that approximately equals an expected maximum waiting time for an IO request. That is, most IO requests in such embodiments are expected to have respective release timestamps within the one generation interval. Establishing the generation interval in this manner reduces the use of multiple generations.

In example operation, the scheduler 140 applies a first timestamp TS1 to a first IO request and applies a second timestamp TSN+1 to a second IO request. The first timestamp TS1 falls within time range T1 of the first generation, and the second timestamp TSN+1 falls within time range TN+1 of the second generation. In this case, bin 1 is provided for both the time range T1 and the time range TN+1. Thus, the scheduler 140 assigns the first IO request and the second IO request to the bin 1 in respective groups of IO requests.

FIG. 3 shows an example multi-generation bin arrangement in greater detail. As shown, bin 1 contains an ordered list 310 with entries linking multiple groups 346, 348 of IO requests for the respective generations. The entries are ordered by generation, e.g., the first generation is earlier in the ordered list 310 than the second generation, and so forth. Other bins of the N bins 152 may have a similar structure, if needed, for accommodating multiple generations. In some embodiments, the ordered list 310 is organized as a linked list. In this manner, entries may be added to the ordered list 310 as new IO requests with release timestamps within new generations are added to the bin. Likewise, entries may be removed as IO requests are released from the bin, enabling the data structure 150 to use memory efficiently.

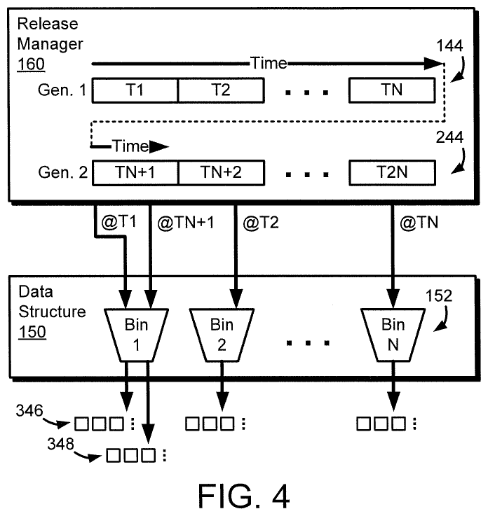

FIG. 4 shows additional features of the example environment 100 in which the IO requests 112 are removed to the N bins 152 based on the generations. As shown, the release manager 160 accesses the N bins 152 to release IO requests from the bins when the current time aligns with the respective time ranges 144, 244. For example, when the current time aligns with time range T1, the release manager 160 accesses the respective bin 1 and releases the group 346 of IO requests with timestamps within the time range T1.

When releasing the IO requests from bin 1, the release manager 160 checks whether the first entry in the ordered list 310 matches a current generation indicated by the current time. If the first entry matches the current generation, then the release manager 160 releases the group of IO requests at that entry. However, if the first entry corresponds to a future generation, then the release manager 160 holds back from releasing the IO requests at that entry. In this manner, the release manager 160 quickly and efficiently determines whether to release IO requests from the bin without needing to check every entry in the ordered list 310.

In some examples, after the release manager 160 finishes releasing IO requests for a current generation from a bin, e.g., after the current time advances to the next time range, the data structure 150 reclaims storage space allocated to storing IO requests for the current generation in the bin, creating space in the data structure 150 for storing IO requests of future generations. In other examples, the allocated storage space may be reclaimed earlier, e.g., as soon as the associated IO requests have been released.”

As the current time advances, the release manager 160 continues to release groups of IO requests from other bins of the N bins 152 until the current time aligns with time range TN, marking the end of the first generation. Continuing further, when the current time advances to the next time range TN+1, the release manager 160 accesses bin 1 again to release the group 348 of IO requests with timestamps within the time range TN+1. In this manner, the release manager 160 accesses the N bins 152 cyclically, with each bin of the N bins 152 being provided for multiple generations.

Advantageously, the embodiments shown in FIGS. 2 through 4 enable the data structure 150 to maintain a fixed number of the bins 152, while enabling the data structure 150 to handle IO requests 112 with release timestamps 142 that exceed the current generation interval.

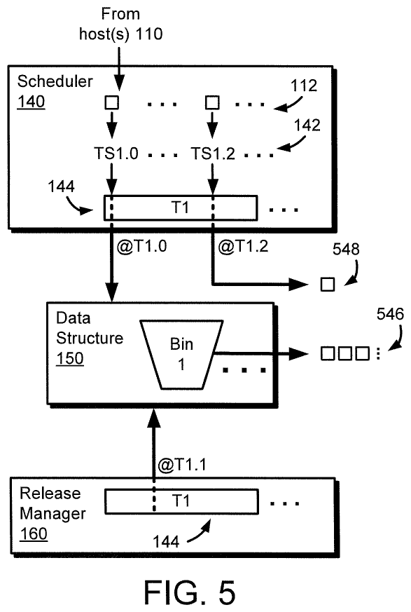

FIG. 5 shows additional features of the example environment 100 in which the release manager 160 repeatedly checks a bin for IO requests as the current time advances within a time range for which the bin is provided.

In example operation, the scheduler 140 applies release timestamps to IO requests and assigns the IO requests 112 to bin 1, e.g., an IO request having a release timestamp TS1.0. As a result, bin 1 contains a group 546 of IO requests at time T1.0. Although FIG. 5 shows time T1.0 within the time range T1, it should be understood that the scheduler 140 may apply release timestamps that fall within time range T1 both before and during the time range T1. Later, at time T1.1, as the current time aligns with the time range T1, the release manager 160 accesses bin 1 and releases all of the IO requests 112 having release timestamps within the time range T1 from the bin, including the group 546 of IO requests.

At this point, bin 1 is empty of IO requests having release timestamps within the time range T1. However, after releasing the IO requests 112 from the bin 1, the scheduler 140 continues to apply release timestamps to new IO requests 112, e.g., an IO request having a release timestamp TS1.2. In this case, the scheduler 140 may simply designate the new IO requests 112 for immediate release without assigning the IO requests 112 to the bin, as the current time still aligns with the time range T1. As a result, at 548, the new IO request 112 is released.

Advantageously, by releasing IO requests multiple times per time range, IO requests with relatively low release timestamps, e.g., high-priority IO requests, may be processed quickly.

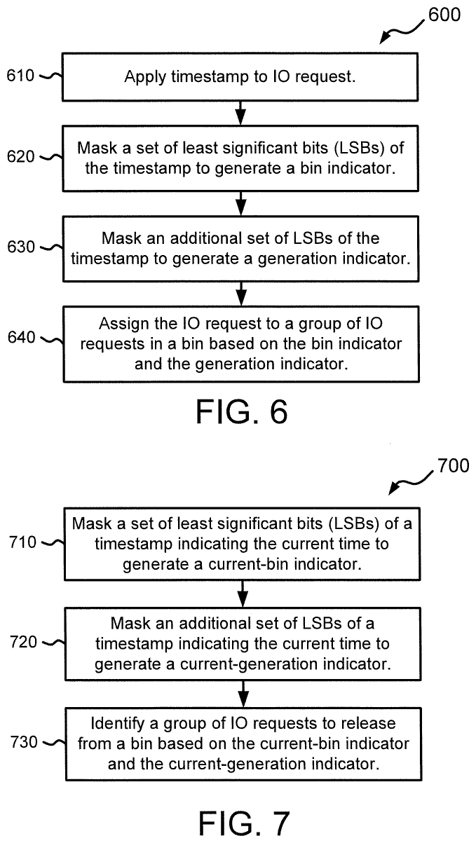

FIG. 6 shows a flowchart of a procedure 600 in which the scheduler 140 assigns an IO request 112 to a bin of the N bins 152 using bitwise operations.

At 610, the scheduler 140 applies a release timestamp 142 to the IO request 112. In some embodiments, the release timestamp is expressed in binary, hexadecimal, or a similar numeral convention. Further, in some embodiments, the release timestamp expressed in units of computer cycles.

At 620, the scheduler 140 masks a set of least significant bits (LSBs) of the release timestamp 142 to generate a bin indicator identifying which of the N bins to assign the IO request 112. For example, the scheduler 140 may use the bitmask 0xFF00 to mask the last two hexadecimal digits of the release timestamp 142. The scheduler 140 then sets the result as the bin indicator for the IO request 112. It should be appreciated that masking may be performed as a bitwise operation, e.g., an AND operation between the release timestamp and the bitmask, which may be performed quickly and efficiently.

At 630, the scheduler 140 masks an additional set of LSBs of the release timestamp 142, e.g., using a bitmask 0xFF 0000 to mask the last four hexadecimal digits of the release timestamp. The scheduler 140 sets the result as a generation indicator identifying a generation of the IO request 112. For example, for a bin containing an ordered list containing multiple groups of IO requests sorted by generation (FIG. 3), the generation indicator identifies which of the groups of IO requests to assign the IO request 112.

At 640, the scheduler 140 assigns the IO request 112 to a group 146 of IO requests in a bin of the N bins 152 as identified by the bin indicator and the generation indicator. In this manner, the scheduler 140 quickly and efficiently sorts the IO requests 112 into the N bins 152.

FIG. 7 shows a flowchart of a procedure 700 in which the release manager 160 releases a group 146 of IO requests from a bin using bitwise operations.

At 710, while the current time aligns with a particular range 144 of release times, the release manager 160 masks a set of LSBs of a timestamp indicating the current time to generate a current-bin indicator. The current-bin indicator identifies a bin of the N bins 152 from which to release IO requests. In some embodiments, the timestamp indicating the current time is expressed similarly to the release timestamps, e.g., in hexadecimal and in units of computer cycles. Further, masking may be performed similar to masking the set of LSBs of the release timestamp as discussed above (step 620 of FIG. 6). In this manner, the current-bin indicator may be the same as one of the bin indicators used to assign the IO requests 112.

At 720, the release manager 160 masks an additional set of LSBs of a timestamp indicating the current time to generate a current-generation indicator. The current-generation indicator identifies a generation of IO requests to release from the bin identified by the bin indicator. For example, for a bin containing an ordered list containing groups of IO requests sorted by generation (FIG. 3), the current-generation indicator identifies which of the groups of IO requests to release for processing. Masking may be performed similar to masking the additional LSBs of a release timestamp as discussed above (step 630 of FIG. 6). In this manner, the current-generation indicator may be the same as one of the generation indicators used to assign the IO requests 112.

At 730, the release manager 160 identifies a group 146 of IO requests to release from a bin as identified by the current-bin indicator and the current-generation indicator. Thus, the release manager 160 may quickly and efficiently release IO requests 112 from the N bins 152.

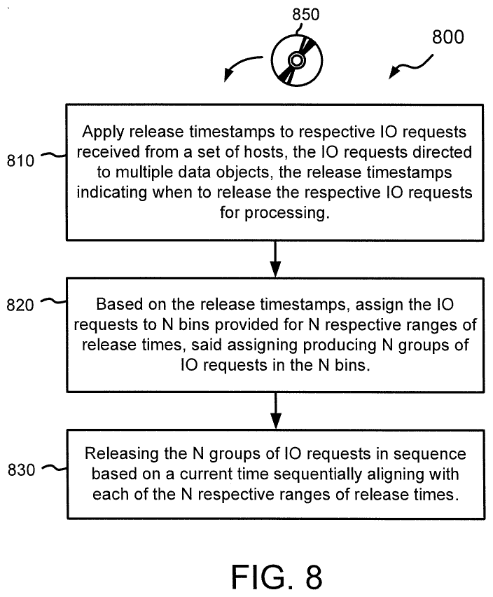

FIG. 8 shows an example method 800 that may be carried out in connection with the environment 100. The method 800 is typically performed, for example, by the software constructs described in connection with FIG. 1, which reside in the memory 130 of the node 120a and are run by the set of processors 124. The various acts of method 800 may be ordered in any suitable way. Accordingly, embodiments may be constructed in which acts are performed in orders different from that illustrated, which may include performing some acts simultaneously.

At 810, the scheduler 140 applies release timestamps 142 to respective IO requests 112 received from a set of hosts 110. The IO requests 112 are directed to multiple data objects in the storage 170. Further, the release timestamps 142 indicate when to release the respective IO requests 112 for processing.

At 820, based on the release timestamps 142, the scheduler 140 assigns the IO requests 112 to N bins 152 provided for N respective ranges 144 of release times, said assigning producing N groups of IO requests 146 in the N bins 142.

At 830, the release manager 160 releases the N groups of IO requests 146 in sequence based on a current time sequentially aligning with each of the N respective ranges 144 of release times.

Having described certain embodiments, numerous alternative embodiments or variations can be made. For example, the data structure 150 may be provided as a sparce matrix, in which elements of the matrix remain empty until the scheduler 140 assigns IO requests to the elements. Further, the lengths of the time ranges 144 may be adjusted based on a desired time granularity at which the groups 146 of IO requests are released. That is, providing smaller time ranges enables the groups 146 of IO requests to be released more often, and vice versa.

Also, although embodiments have been described which involve one or more data storage systems, other embodiments may involve computers, including those not normally regarded as data storage systems. Such computers may include servers, such as those used in data centers and enterprises, as well as general purpose computers, personal computers, and numerous devices, such as smart phones, tablet computers, personal data assistants, and the like.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 850 in FIG. 8). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of processing input/output (IO) requests, comprising:
applying release timestamps to respective IO requests received from a set of hosts, the IO requests directed to multiple data objects, the release timestamps indicating when to release the respective IO requests for processing;
based on the release timestamps, assigning the IO requests to N bins provided for N respective ranges of release times, said assigning producing N groups of IO requests in the N bins; and
releasing the N groups of IO requests in sequence based on a current time sequentially aligning with each of the N respective ranges of release times.

2. The method of claim 1, wherein releasing the N groups of IO requests includes:
releasing, from a first bin of the N bins, a first group of IO requests of the N groups of IO requests based on the current time aligning with a first range of release times of the N respective ranges of release times; and
releasing, from a second bin of the N bins, a second group of IO requests of the N groups of IO requests based on the current time aligning with a second range of release times of the N respective release times, the second range of release times being subsequent to the first range of release times.

3. The method of claim 1, further comprising:
applying a release timestamp to an additional IO request, the release timestamp falling within an additional range of release times subsequent to the N ranges of release times, a particular bin of the N bins provided for the additional range of release times in addition to one of the N ranges of release times; and
based on the release timestamp, assigning the additional IO request to the particular bin.

4. The method of claim 3, wherein assigning the IO requests to the N bins produces a first group of IO requests in the particular bin and assigning the additional IO request to the particular bin produces a second group of IO requests in the particular bin; and
wherein releasing the N groups of IO requests includes releasing the first group of IO requests from the particular bin while holding back the second group of IO requests from the particular bin.

5. The method of claim 4, wherein assigning the additional IO request to the particular bin includes linking the first group of IO requests and the second group of IO requests together in an ordered list, the ordered list separating the first group of IO requests from the second group of IO requests.

6. The method of claim 4, further comprising, after releasing the first group of IO requests, releasing the second group of IO requests based on the current time aligning with the additional range of release times, the one of the N ranges of release times separated from the additional range of release times by N−1 contiguous ranges of release times.

7. The method of claim 1, wherein releasing the N groups of IO requests includes releasing a group of IO requests from a bin while the current time aligns with a range of release times for which the bin is provided; and
wherein the method further comprises, after releasing the group of IO requests and while the current time still aligns with the range of release times, assigning a set of additional IO requests to the bin and releasing the set of additional IO requests, the set of additional IO requests having a set of release timestamps within the range of release times.

8. The method of claim 1, wherein assigning the IO requests to the N bins includes performing bitwise operations on the release timestamps, the bitwise operations generating bin indicators identifying the N bins in which to assign the IO requests.

9. The method of claim 8, wherein performing the bitwise operations includes masking respective sets of least significant bits of the release timestamps to generate the bin indicators.

10. The method of claim 9, wherein performing the bitwise operations further includes masking respective sets of additional least significant bits of the release timestamps to generate generation indicators identifying the N groups of IO requests in which to assign the IO requests within the bins.

11. The method of claim 1, wherein releasing the N groups of IO requests includes:
while the current time aligns with a particular range of release times, calculating a current-bin indicator based on the current time, the current-bin indicator identifying a bin of the N bins; and
identifying for release a group of IO requests assigned to the bin identified by the current-bin identifier.

12. The method of claim 11, wherein calculating the current-bin indicator includes reading a timestamp that indicates the current time and masking a portion of the timestamp.

13. The method of claim 11, further comprising:
calculating a current-generation indicator based on the timestamp that indicates the current time; and
wherein identifying for release the group of IO requests includes:
based on the generation indicator, identifying the group of IO requests from an ordered list within the bin identified by the current-bin identifier.

14. A computerized apparatus, comprising control circuitry that includes a set of processors coupled to memory, the control circuitry constructed and arranged to:
apply release timestamps to respective IO requests received from a set of hosts, the IO requests directed to multiple data objects, the release timestamps indicating when to release the respective IO requests for processing;
based on the release timestamps, assign the IO requests to N bins provided for N respective ranges of release times, said assigning producing N groups of IO requests in the N bins; and
release the N groups of IO requests in sequence based on a current time sequentially aligning with each of the N respective ranges of release times.

15. The computerized apparatus of claim 14, wherein releasing the N groups of IO requests includes:
releasing, from a first bin of the N bins, a first group of IO requests of the N groups of IO requests based on the current time aligning with a first range of release times of the N respective ranges of release times; and
releasing, from a second bin of the N bins, a second group of IO requests of the N groups of IO requests based on the current time aligning with a second range of release times of the N respective release times, the second range of release times being subsequent to the first range of release times.

16. The computerized apparatus of claim 14, further comprising:
applying a release timestamp to an additional IO request, the release timestamp falling within an additional range of release times subsequent to the N ranges of release times, a particular bin of the N bins provided for the additional range of release times in addition to one of the N ranges of release times; and
based on the release timestamp, assigning the additional IO request to the particular bin.

17. The computerized apparatus of claim 16, wherein assigning the IO requests to the N bins produces a first group of IO requests in the particular bin and assigning the additional IO request to the particular bin produces a second group of IO requests in the particular bin; and
wherein releasing the N groups of IO requests includes releasing the first group of IO requests from the particular bin while holding back the second group of IO requests from the particular bin.

18. A computer program product including a set of non-transitory, computer-readable media having instructions which, when executed by control circuitry of a computerized apparatus, cause the computerized apparatus to perform a method of processing IO requests, the method comprising:
applying release timestamps to respective IO requests received from a set of hosts, the IO requests directed to multiple data objects, the release timestamps indicating when to release the respective IO requests for processing;
based on the release timestamps, assigning the IO requests to N bins provided for N respective ranges of release times, said assigning producing N groups of IO requests in the N bins; and
releasing the N groups of IO requests in sequence based on a current time sequentially aligning with each of the N respective ranges of release times.
